(19) United States
(12) Patent Application Publication
(10) Pub. No.: US 2010/0054804 A1
(43) Pub. Date: Mar. 4, 2010

(54) CARTRIDGE AND ELECTROPHOTOGRAPHIC IMAGE FORMING APPARATUS

(75) Inventors: Tetsushi Uneme, Susono-shi (JP); Takahito Ueno, Mishima-shi (JP); Yuuki Nakamura, Suntou-gun (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/547,992

(22) Filed: Aug. 26, 2009

(30) Foreign Application Priority Data
Sep. 1, 2008 (JP) 2008-223044
Aug. 4, 2009 (JP) 2009-181143

(51) Int. Cl. G03G 15/08

(52) U.S. Cl. 399/119

(57) ABSTRACT

A cartridge detachably mountable to a main assembly of an electrophotographic image forming apparatus includes a developer carrying member for developing an electrostatic latent image formed on an image bearing member, and an electroconductive developer layer thickness regulating member for regulating a layer thickness of a developer deposited on the developer carrying member. A part of the developer layer thickness regulating member is directly contactable to the main assembly electrical contact.

### FIELD OF THE INVENTION AND RELATED ART

The present invention relates to a cartridge and an electrophotographic image forming apparatus to which the cartridge is detachably mountable.

In a conventional electrophotographic image forming apparatus, an electrostatic latent image formed on an electrophotographic portion is developed by a developing means including a developing roller and a developing blade to be visualized as a toner image. In such an image forming apparatus, a constitution in which the developing means including the developing roller and the developing blade is prepared by integrally supporting the roller and the blade into a cartridge and the resultant developing cartridge is detachably mountable to a main assembly of the image forming apparatus has been known.

In order to develop the electrostatic latent image formed on the photosensitive drum by depositing toner on the electrostatic latent image, it is necessary to apply a bias voltage to the developing means. For this purpose, the developing cartridge and the main assembly of the electrophotographic image forming apparatus are electrically connected to each other and a voltage is supplied from the main assembly to the developing cartridge.

A constitution for supplying the voltage from the main assembly of the electrophotographic image forming apparatus to the developing cartridge will be described. The developing cartridge is provided with input electrical contacts connected to respective constituent members such as the developing roller and the developing blade. The main assembly is provided with main assembly electrical contacts which contacts the respective input electrical contacts provided to the developing cartridge when the developing cartridge is mounted to the main assembly. By the contact of the input electrical contacts, connected to the respective constituent members, with the main assembly electrical contacts of the main assembly, it is possible to supply a voltage from the main assembly to the developing cartridge (Japanese Laid-Open Patent Application No. 2004-117806).

In this case, the voltage supply from the main assembly to the developing cartridge is enabled by providing to the developing cartridge an electrical contact member connected to both of the input electrical contacts, connected to the respective constituent members such as the developing roller and the developing blade constituting the developing cartridge, and the main assembly electrical contacts of the main assembly.

However, in recent years, the developing cartridge has been required to realize further simplification, further cost reduction, and further space saving.

### SUMMARY OF THE INVENTION

A principal object of the present invention is to simplify a constitution for electrically connecting a main assembly of an electrophotographic image forming apparatus to a cartridge by reducing the number of parts so as to realize cost reduction and space saving.

According to an aspect of the present invention is to provide a cartridge detachably mountable to a main assembly of an electrophotographic image forming apparatus having a main assembly electrical contact, the cartridge comprising:

a developer carrying member for developing an electrostatic latent image formed on an image bearing member; and

an electroconductive developer layer thickness regulating member for regulating a layer thickness of a developer deposited on the developer carrying member;

wherein a part of the developer layer thickness regulating member is directly contactable to the main assembly electrical contact.

According to another aspect of the present invention is to provide an electrophotographic image forming apparatus for forming an image on a recording material, comprising:

(a) a main assembly electrical contact;

(b) a cartridge detachably mountable to a main assembly of an electrophotographic image forming apparatus having a main assembly electrical contact, the cartridge comprising:

a developer carrying member for developing an electrostatic latent image formed on an image bearing member; and

an electroconductive developer layer thickness regulating member for regulating a layer thickness of a developer deposited on the developer carrying member;

wherein a part of the developer layer thickness regulating member is directly contactable to the main assembly electrical contact; and

(c) conveying means for conveying the recording material.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIGS. 1 and 2 are sectional views each showing an image forming apparatus.

FIG. 3 is a perspective view of an outer appearance of a developing cartridge.

FIGS. 4(a) and 4(b) are sectional views each showing a schematic structure of the developing cartridge.

FIG. 5(a) is a perspective view of a developing roller, FIG. 5(b) is a perspective view of a toner supplying roller, and FIG. 5(c) is a perspective view of the developing cartridge for illustrating a roller supporting structure.

FIGS. 6, 7 and 8 are sectional views each showing a mounting and demounting position of the developing cartridge.

FIG. 9(a) is a perspective view of a developing blade and FIG. 9(b) is a perspective view of an outer appearance of the developing cartridge.

FIG. 10 is a sectional view showing a relationship between main assembly electrical contacts and the developing blade before the developing cartridge is mounted.

FIGS. 11(a) and 11(b) are perspective views each showing a state in which the main assembly electrical contact contacts a developing blade contact surface of the developing blade.

FIGS. 12(a) and 12(b) are sectional views each showing a relationship between the main assembly electrical contacts and the developing blade after the developing cartridge is mounted.

### DESCRIPTION OF THE PREFERRED EMBODIMENTS

Hereinbelow, with reference to the drawings, embodiments of a cartridge detachably mountable to a main assembly of an electrophotographic image forming apparatus will be described. In the following description, the electrophotographic image forming apparatus to which a developing cartridge is detachably mountable will be described as an example.

However, the present invention is not limited thereto. The cartridge detachably mountable to the main assembly of the electrophotographic image forming apparatus may also be a process cartridge.

Here, the developing cartridge is prepared by integrally supporting a developer carrying member and a developer layer thickness regulating member into a cartridge. Further, the process cartridge is prepared by integrally supporting an image bearing member and a developing means as a process means acting on the image bearing member into a cartridge. These cartridges are detachably mountable to the main assembly of the electrophotographic image forming apparatus by a user.

Further, the electrophotographic image forming apparatus forms an image on a recording material by using an electrophotographic image forming system. Examples of the electrophotographic image forming apparatus may include an electrophotographic copying machine, an electrophotographic printer (an LED printer, a laser beam printer, or the like), a facsimile machine, and a word processor.

The recording material is a material or medium on which the image is to be formed and may include, e.g., paper, a sheet material, and an OHP sheet.

The main assembly of the electrophotographic image forming apparatus is an electrophotographic image forming apparatus portion excluding the cartridge.

### First Embodiment

### (General Structure of Electrophotographic Image Forming Apparatus)

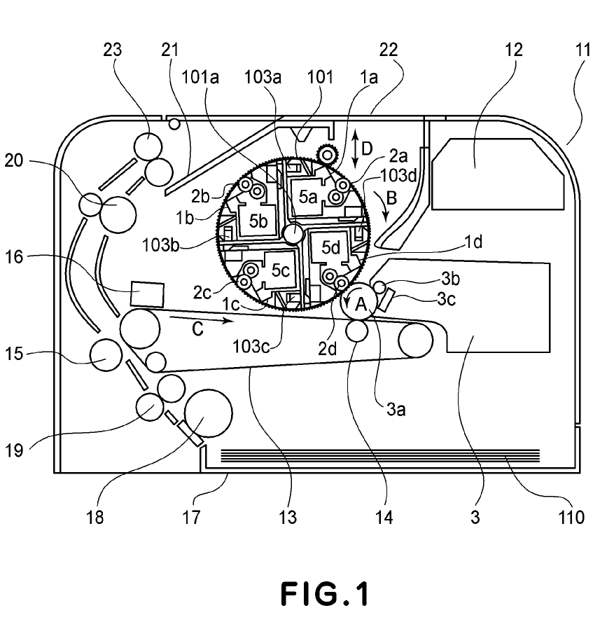

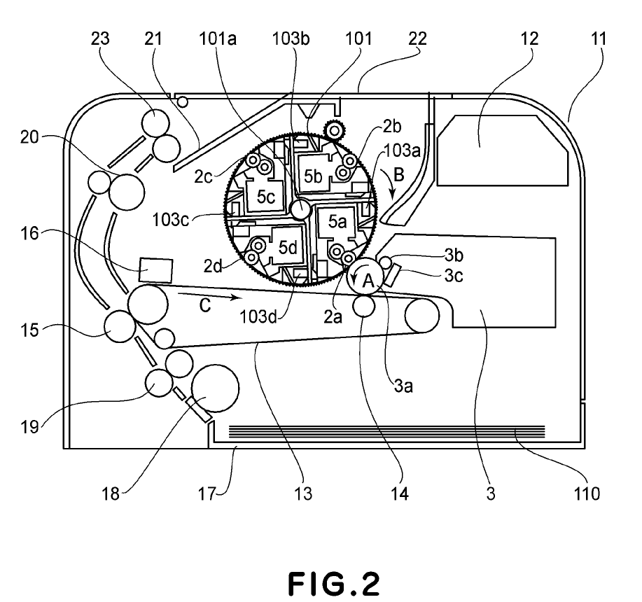

First, with reference to FIGS. 1 and 2, a general structure and an image forming operation of the electrophotographic image forming apparatus will be described.

FIG. 1 and FIG. 2 are sectional views each showing an image forming apparatus main assembly 11 of the image forming apparatus and a developing cartridge 5.

The image forming apparatus shown in each of FIG. 1 and FIG. 2 is a four color-based full-color laser beam printer to which four developing cartridges 5 and a single drum cartridge 3 are detachably mountable. In a state in which the drum cartridge 3 and the developing cartridges 5 are mounted in the main assembly 11, an exposure means (a laser scanner unit) 12 is disposed above the drum cartridge 3. Further, below the cartridges 3 and 5, a sheet feeding cassette 17 accommodating the recording material (hereinafter referred to as a sheet) 110 is disposed. In the main assembly 11, along a conveyance direction of the sheet 110, members including a feeding roller 18, a conveying roller 19, a secondary transfer roller 15, a fixing device 20, a sheet discharging roller 23, a sheet discharging portion 21, and the like are disposed. The feeding roller 18, the conveying roller 19, the sheet discharging roller 23, and the like constitute a conveying means for conveying the sheet. An intermediary transfer belt 13 is an intermediary transfer member for temporarily carrying and conveying a developer image formed on an image bearing member (photosensitive drum) 3a. A primary transfer roller 14 is a transfer roller for primary-transferring the developer image from the photosensitive drum 3a onto the intermediary transfer belt 13. A cleaning unit 16 removes a developer (toner) remaining on the intermediary transfer belt 13 after transfer.

The drum cartridge 3a is prepared by integrally supporting the photosensitive drum 3a, and a charging means 3b and a cleaning means 3c, which are process means acting on the photosensitive drum 3a, into a cartridge, which is detachably mountable to the main assembly 11. The charging means 3b electrically charges the photosensitive drum 3a uniformly. The cleaning means 3c removes the toner remaining on the photosensitive drum 3a after the transfer. Incidentally, it is also possible to employ a constitution in which the photosensitive drum 3a, the charging means 3b and the cleaning means 3c are independently prepared.

Each of the developing cartridges 5 is developing device (developing means) for developing the electrostatic latent image formed on the photosensitive drum 3a with associated (color) toner to visualize the electrostatic latent image. In this embodiment, as described above, the four developing cartridges are used and includes a developing cartridge yellow 5a, a magenta developing cartridge 5b, a cyan developing cartridge 5a, and a black developing cartridge 5d. The yellow developing cartridge 5a, the magenta developing cartridge 5b, the cyan developing cartridge 5c, and the black developing cartridge 5d are held by a rotary 101 rotatably mounted to the main assembly 11. The yellow developing cartridge 5a, the magenta developing cartridge 5b, the cyan developing cartridge 5c, and the black developing cartridge 5d are detachably mountable to the rotary 101. As described later specifically, each developing cartridge includes a developing roller (the developer carrying member) 2 for developing the electrostatic latent image formed on the photosensitive drum 3a and includes an electroconductive developing blade (the developer layer thickness regulating member) 1 for regulating a layer thickness of the toner to be deposited on the developing roller 2. As shown in FIG. 1, the yellow developing cartridge 5a includes the developing roller 2a and the developing blade 1a. The magenta developing cartridge 5b includes the developing roller 2b and the developing blade 1b. The cyan developing cartridge 5c includes the developing roller 2c and the developing blade 1c. The black developing cartridge 5d includes the developing roller 2d and the developing blade 1d.

The rotary 101 has constitutes for holding the yellow developing cartridge 5a, the magenta developing cartridge 5b, the cyan developing cartridge 5c, and the black developing cartridge 5d which are similar to each other. Therefore, in this embodiment, as the constitute for holding the developing cartridge 5 by the rotary 101, that for the yellow developing cartridge 5a will be described as an example.

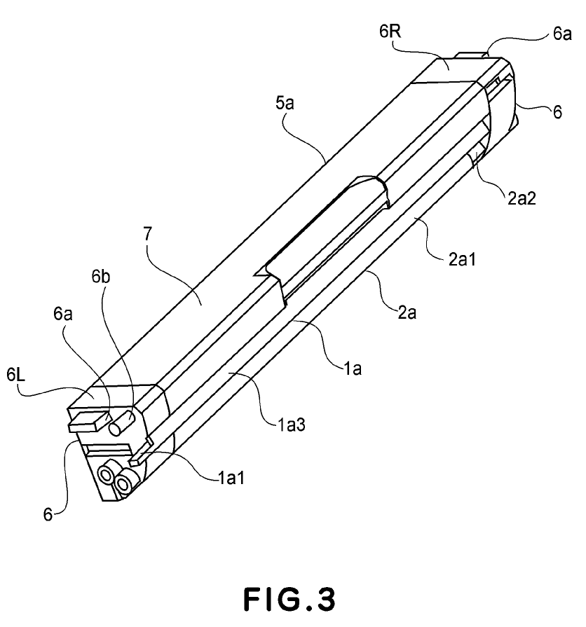

As shown in FIG. 3, the yellow developing cartridge 5a includes a portion 6a to be locked as a portion to be guided and includes a rotation preventing portion (a portion to be positioned) 6b as the portion to be guided. When the yellow developing cartridge 5a is mounted to and demounted from the rotary 101, the portions to be guided (the portion 6a to be locked and the rotation preventing portion 6b) are guided by a guide portion 101c provided to the rotary 101. In a state in which the yellow developing cartridge 5a is mounted to the rotary 101, the portion 6a to be locked is locked by a developing cartridge locking member 103a provided to the rotary 101. As a result, disengagement of the yellow developing cartridge 5a from the rotary 101 is suppressed. The developing cartridge locking member 103a is urged by a spring (not shown) in a direction, of an arrow D indicated in FIG. 1, in which the developing cartridge locking member 103a is engageable with the yellow developing cartridge 5a. Incidentally, with respect to other developing cartridges 5b, 5c and 5d, the disengagement of the developing cartridges 5b, 5c and 5d from the rotary 101 is suppressed by engaging portions to be locked, provided to the respective developing cartridges 5b, 5c and 5d, with developing cartridge locking members 103b, 103c and 104d, respectively, provided to the rotary 101. In this embodiment, the portion 6a to be locked and the rotation preventing portion 6b are projected from a frame of the developing cartridge 5a with respect to a longitudinal direction of the developing cartridge 5a.

First, the photosensitive drum 3a is rotated in a direction of an arrow A indicated in FIG. 1. In synchronism with the rotation of the photosensitive drum 3a, the intermediary transfer belt 13 is rotated in a direction of an arrow C indicated in FIG. 1. Then, the surface of the photosensitive drum 3a is charged uniformly by the charging means 3b and at the same time is exposed to light for an yellow image by the exposure means 12, so that an electrostatic latent image for yellow is formed on the photosensitive drum 3a.

Simultaneously with the formation of the electrostatic latent image, the rotary which holds the respective developing cartridges 5a, 5b, 5c and 5d is rotated about a rotary rotational shaft 101a in a direction of an arrow B indicated in FIG. 1 by a drive transmission mechanism provided to the main assembly 11. As a result, the yellow developing cartridge 5a is positioned at a developing position in which the yellow developing cartridge 5a opposes the photosensitive drum 3a (a state shown in FIG. 2).

A potential difference is provided between the photosensitive drum 3a and the developing roller 2a so that yellow toner is deposited on the latent image formed on the photosensitive drum 3a. As a result, the yellow toner is deposited on the latent image formed on the photosensitive drum 3a to develop the latent image. That is, a yellow toner image is formed on the photosensitive drum 3a.

Thereafter, a voltage of an opposite polarity to the charge polarity of the toner is applied to the primary transfer roller 14 disposed inside the intermediary transfer belt 13 to primary-transfer the yellow toner image from the photosensitive drum 3a onto the intermediary transfer belt 13.

In the above-described manner, when the primary transfer of the yellow toner image is completed, the rotary 101 is rotationally moved in the direction of the arrow B indicated in FIG. 2 by being supplied with a driving force from the drive transmission mechanism of the main assembly 11. Thus, the magenta developing cartridge 5b, the cyan developing cartridge 5c, and the black developing cartridge 5d are successively positioned at the developing position in which an associated developing cartridge opposes the photosensitive drum 3a. At the developing position, similarly as in the case of yellow, the electrostatic latent image is formed and developed and an associated toner image is primary-transferred with respect to magenta, cyan and black, so that the resultant four color toner images are superposed on the intermediary transfer belt 13.

During these steps, the secondary transfer roller 15 is in a non-contact state with the intermediary transfer belt 13 as shown in FIG. 1. Further, the cleaning unit 16 for the intermediary transfer belt 13 is also in a non-contact state with the intermediary transfer belt 13.

The sheet 110 stacked and accommodated in the feeding cassette 17 is separated one by one and fed toward the conveying roller 19 by the feeding roller 18. The conveying roller 19 sends the fed sheet 110 to a position between the intermediary transfer belt 13 and the secondary transfer roller 15. At this position, as shown in FIG. 2, the secondary transfer roller 15 is in a contact state with the intermediary transfer belt 13.

Further, to the secondary transfer roller 15, a voltage of an opposite polarity to the charge polarity of the toner is applied, so that the four color toner images superposed on the intermediary transfer belt 13 as described above are secondary-transferred onto the surface of the conveyed sheet 110.

The sheet 110 on which the toner images are transferred is sent to the fixing device 20. In the fixing device 20, the sheet 110 is heated and pressed, so that the toner images are fixed on the sheet 110. As a result, an image is formed on the sheet 110. Thereafter, the sheet 110 is discharged onto the sheet discharge portion 21 outside the main assembly 11 by the sheet discharging roller 23.

### (Developing Cartridge)

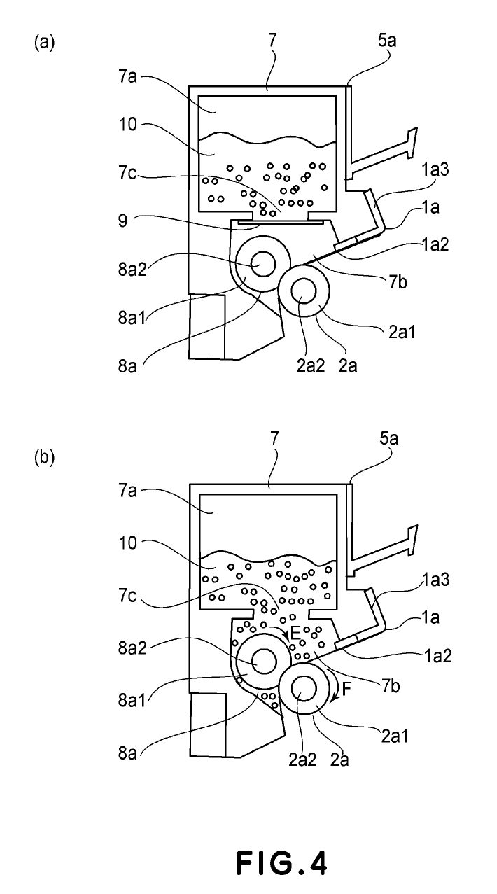

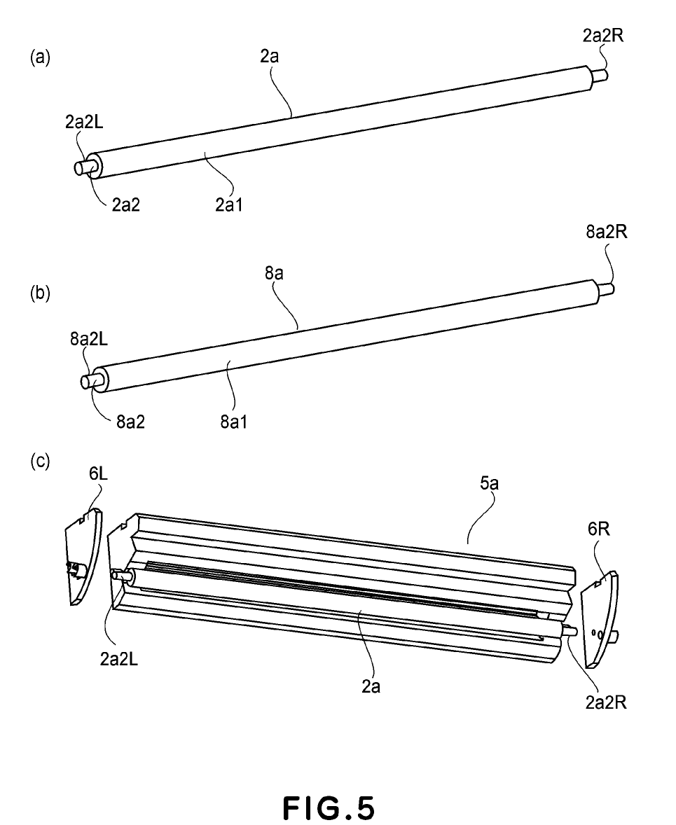

The yellow developing cartridge 5a, the magenta developing cartridge 5b, the cyan developing cartridge 5c, and the developing cartridge black developing cartridge 5d have the same constitution. Therefore, the constitution of the developing cartridge will be described by taking the yellow developing cartridge 5a as an example. Hereinbelow, the constitution of the developing cartridge will be described with reference to FIGS. 4(a) and 4(b) and FIGS. 5(a), 5(b) and 5(c).

FIGS. 4(a) and 4(b) are sectional views showing the yellow developing cartridge 5a, FIG. 5(a) is a perspective view of the developing roller, FIG. 5(b) is a perspective view of a toner supplying roller, and FIG. 5(c) is a perspective view of the yellow developing cartridge for illustrating a roller supporting constitution.

A developing container 7 as a frame for the yellow developing cartridge 5a is vertically separated into a toner accommodating chamber 7a and a developing chamber 7b which includes the developing roller 2a and the toner supplying roller 8a by a toner supply opening 7c. The developer container 7 also includes side members 6L and 6R. In an unused state until the yellow developing cartridge 5a is delivered to the user, as shown in FIG. 4(a), at the toner supply opening 7c, a film-like toner seal 9 for separating the toner accommodating chamber 7a and the developing chamber 7b from each other is fixed to the developing container 7 by a method such as welding.

By removing the toner seal 9 before use, toner 10 in the toner accommodating chamber 7a falls freely in the developing chamber 7b as shown in FIG. 4(b) at a position in which the yellow developing cartridge 5a opposes the photosensitive drum 3a as shown in FIG. 2.

The developing roller 2a is, as shown in FIG. 4(a), constituted by a rubber roller portion 2a1 and a rigid shaft 2a2. The rigid shaft 2a2 penetrates through the rubber roller portion 2a1 in a rotational axis direction the developing roller 2a and forms, as shown in FIG. 5(a), projected portions 2a2L and 2a2R projected from the rubber roller portion 2a1 at both end portions thereof.

The toner supplying roller 8a is, as shown in FIG. 4(a), constituted by a sponge roller portion 8a1 and a rigid shaft 8a2. The rigid shaft 8a2 penetrates through the sponge roller portion 8a1 in a rotational axis direction toner supplying roller 8a and forms, as shown in FIG. 5(b), projected portions 8a2L and 8a2R projected from the sponge roller portion 8a1 at both end portions thereof.

The supporting constitution of the toner supplying roller 8a by the yellow developing cartridge 5a is similar to that of the developing roller 2a by the yellow developing cartridge 5a. Therefore, the roller supporting constitution by developing cartridge will be described by taking the supporting constitution of the developing roller 2a by the yellow developing cartridge 5a as an example. The yellow developing cartridge 5a, as shown in FIG. 5(c), rotatably holds the developing roller 2a by the side members 6L and 6R which hold the projected portions 2a2L and 2a2R, respectively, of the developing roller 2a.

The toner 10 in the developing chamber 7b is fed to the toner supply roller 8a, which is rotated in a direction of an arrow E indicated in FIG. 4(b) to feed the toner 10 to the developing roller 2a. The developing roller 2a is rotated in a direction of an arrow F indicated in FIG. 4(b) and then the toner 10 on the developing roller 2a is regulated by the developing blade 1a to be subjected to development on the photosensitive drum 3a. After the development, the toner 10 remaining on the developing roller 2a is removed by the toner supplying roller 8a. Thereafter, the toner 10 is supplied again to the developing roller 2a by the toner supplying roller 8a. The developing roller 2a is supplied with a voltage from the main assembly 11 so as to provide a potential difference between the developing roller 2a and the photosensitive drum 3a. The toner supplying roller 8a is also supplied with a voltage from the main assembly 11.

At the developing position, in order to stably bring the developing roller 2a into contact with the photosensitive drum 3a, the rotary 101 by which the yellow developing cartridge 5a is held is urged toward the photosensitive drum 3a. As a result, the developing roller 2a of the yellow developing cartridge 5a is placed in a state in which the developing roller 2a contacts the photosensitive drum 3a at a predetermined urging force.

(Mounting and Demounting Method of Developing Cartridge with Respect to Image Forming Apparatus Main Assembly)

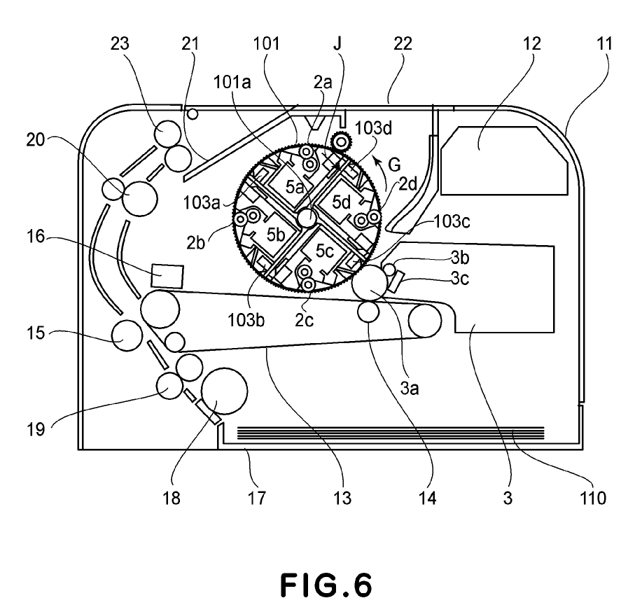

Next, with reference to FIGS. 6 to 8, a mounting and demounting operation of the yellow developing cartridge 5a, the magenta developing cartridge 5b, the cyan developing cartridge 5c, and the black developing cartridge 5d with respect to the image forming apparatus main assembly 11 will be described.

The rotary 101 is, as shown in FIG. 6, on standby in a period other than during the developing operation at a position in which the developing roller 2a is rotated about the rotary rotational shaft 101a to a phase at which the developing roller 2a is moved away from the photosensitive drum 3a. In this case, a stand-by position of the black developing cartridge 5d is a position rotated by 45 degrees from the developing position in a direction of an arrow G indicated in FIG. 6. Movement of each developing cartridge to an associated stand-by position is automatically performed by the drive transmission mechanism after completion of the image forming operation. The stand-by position of the black developing cartridge 5d shown in FIG. 6 is used as a mounting and demounting position of the developing cartridge.

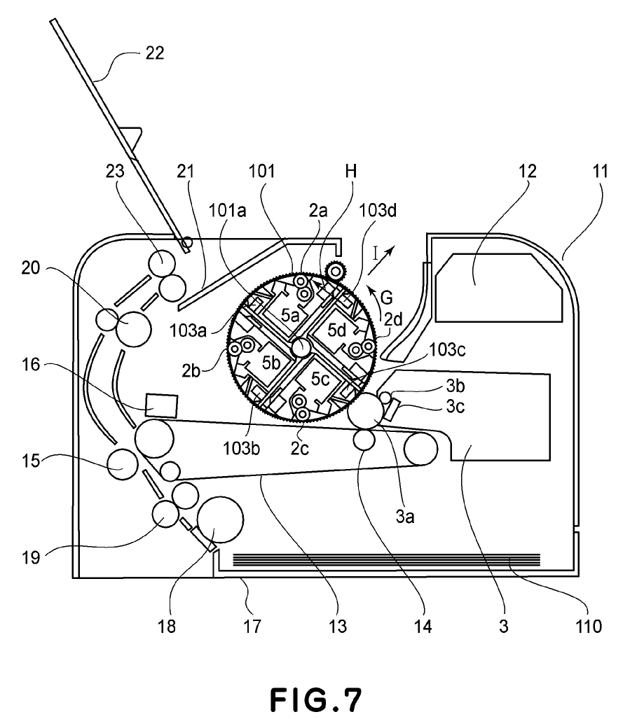

At the mounting and demounting position, as shown in FIG. 7, the developing cartridge locking member 103d is retracted in a direction of an arrow H indicated in FIG. 7 by opening a mounting and demounting cover 22 to disengage the portion 6d to be looked of the black developing cartridge 6d. As a result, the black developing cartridge 5d can be mounted to and demounted from the rotary 101 with respect to a direction of an arrow I, as a mounting and demounting direction, indicated in FIG. 7.

The mounting and demounting operation for the yellow developing cartridge 5a, the magenta developing cartridge 5b, and the cyan developing cartridge 5c is also similarly performed. The mounting and demounting operation of the developing cartridge will be described more specifically by taking that of the yellow developing cartridge 5a as an example.

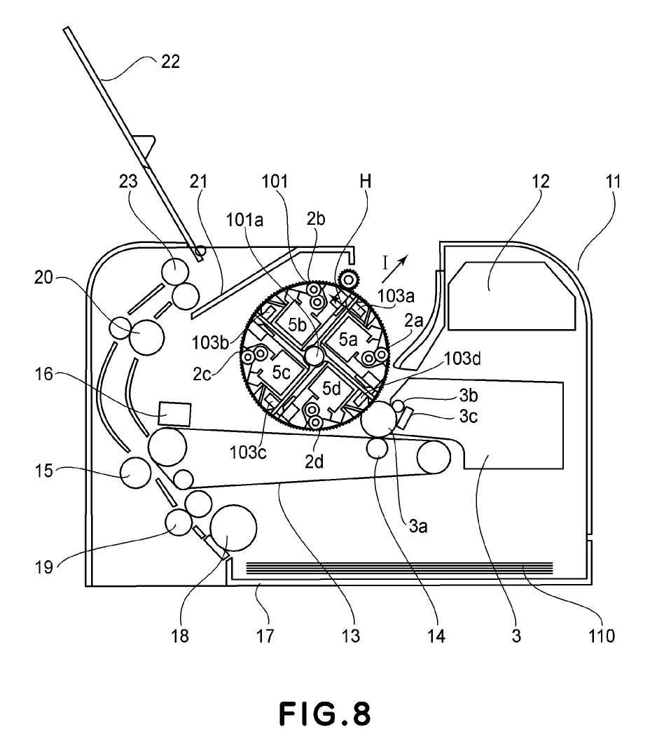

The mounting and demounting of the yellow developing cartridge 5a can be performed only at the above-described mounting and demounting position. Movement of the yellow developing cartridge 5a to the mounting and demounting position can be performed by the drive transmission mechanism or by directly moving the rotary 101 manually. When the yellow developing cartridge 5a is moved to the mounting and demounting position, as shown in FIG. 8, the portion 6a to be locked of the yellow developing cartridge 5a is disengaged by retracting the developing cartridge locking member 103a in the direction of the arrow H indicated in FIG. 8 through the opening of the mounting and demounting cover 22. As a result, the yellow developing cartridge 5a can be mounted to and demounted from the rotary 101 in the direction of the arrow I, as the mounting and demounting direction, indicated in FIG. 8.

When the user closers the mounting and demounting cover 22, as shown in FIG. 6, the locking member 103a is moved in a direction of an arrow J indicated in FIG. 6 to be engaged with the portion 6a to be locked of the yellow developing cartridge 5a. As a result, disengagement of the yellow developing cartridge 5a from the rotary 101 is suppressed.

### (Developing Blade Supporting Constitution in Developing Cartridge)

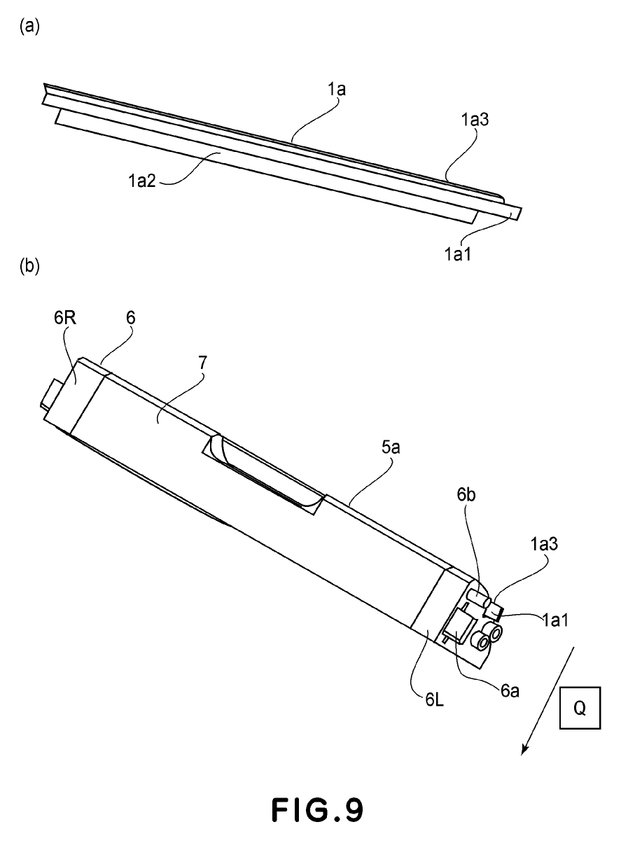

Next, with reference to FIGS. 4(a) and 4(b) and FIGS. 9(a) and 9(b), the developing blade supporting constitution in the developing cartridge will be described. FIG. 9(a) is a perspective view of the developing blade and FIG. 9(b) is a perspective view of an outer appearance of the developing cartridge.

The developing blade 1a is, as shown in FIGS. 4(a) and 5(b) and FIG. 9(a), constituted by a layer thickness regulating member 1a2 and a holding member 1a3 and the layer thickness regulating member 1a2 is bonded to the holding member 1a3. In this case, these members 1a2 and 1a3 are bonded by using YAG welding but another boding method may also be employed.

As shown in FIGS. 4(a) and 4(b), the developing blade 1a is fixed to the developing container 7 at a portion of the holding member 1a3 so that the layer thickness regulating member 1a2 contacts the developing roller 2a.

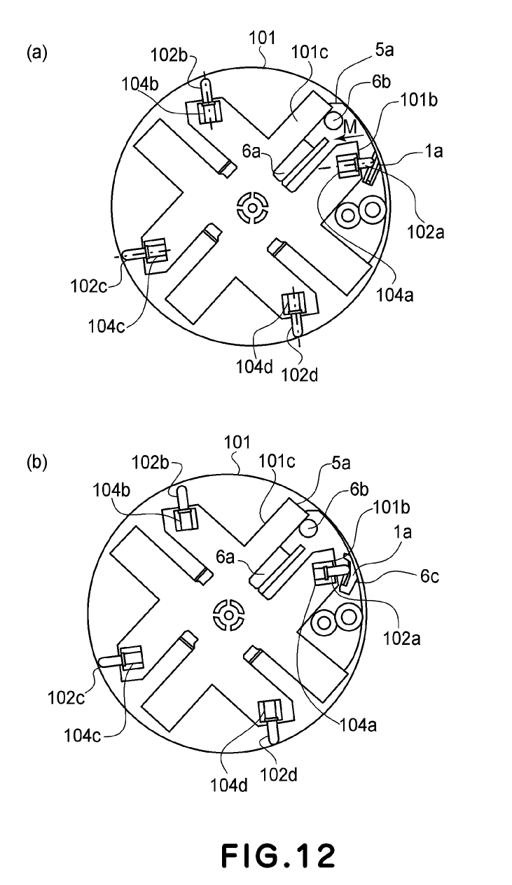

The developing blade 1a is exposed from the developing cartridge 5 so that a part thereof directly contacts a main assembly electrical contact 102a (FIGS. 12(a) and 12(b)) provided to the main assembly 11. In this case, as shown in FIG. 9(a), a developing blade contact surface 1a1 which is a contact portion with the main assembly electrical contact 102a is provided to a part of the holding member 1a3 of the developing blade 1a. This developing blade contact surface 1a1 is projected from an outer appearance shape (longitudinal end portion) of the developing cartridge 5a. In this case, as shown in FIG. 9(b), the developing blade contact surface 1a1 is projected from the side member 6L (a frame end portion) of the yellow developing cartridge 5a with respect to the longitudinal direction of the developing blade 1a. Incidentally, the magenta developing cartridge 5b, the cyan developing cartridge 5c, and the black developing cartridge 5d are also constituted similarly. The contact surface 1a1 is disposed oppositely to the projected portions (the portion 6a to be locked and the rotation preventing portion 6b) projected from the frame end portion of the cartridge 5a. As a result, the contact surface 1a1 is prevented from being touched by the user. The above constitution is particularly effective to prevent the contact surface 1a1 from being touched by the user when an electroconductive agent (an electroconductive grease or the like) is applied onto the contact surface 1a1. Further, the contact surface 1a1 is directed downwardly (in a direction of an arrow Q indicated in FIG. 9(b)) in the case where the cartridge 5a is mounted outside the main assembly. Also by this constitution, it is possible to suppress the touch of the contact surface 1a1 by the user.

(Constitution for Applying Voltage from Image Forming Apparatus Main Assembly to Developing Blade)

Next, with reference to FIGS. 1, 2 and 10 to 12(b), a constitution for applying a voltage from the image forming apparatus main assembly to the developing blade 1 of each developing cartridge 5 will be described. The same constitution for applying the voltage from the main assembly to the developing blade of the developing cartridge is employed with respect to the developing blades 1a, 1b, 1c and 1d. Therefore, description will be made by taking the constitution for applying the voltage from the main assembly to the yellow developing cartridge 5a as an example.

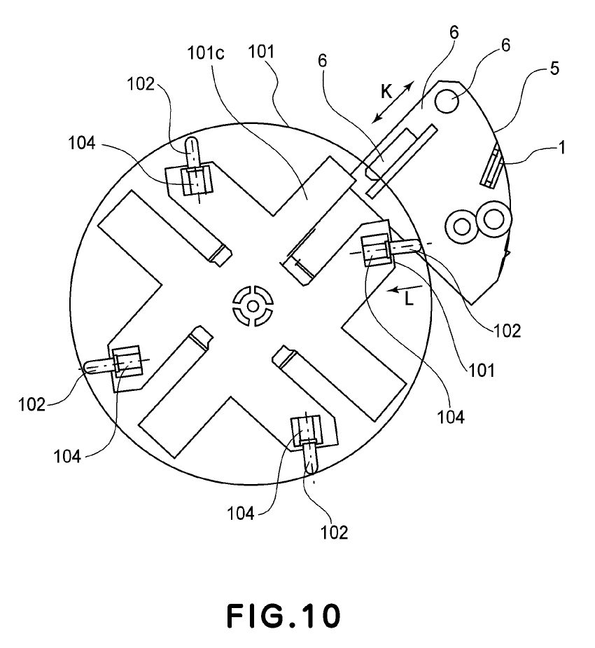

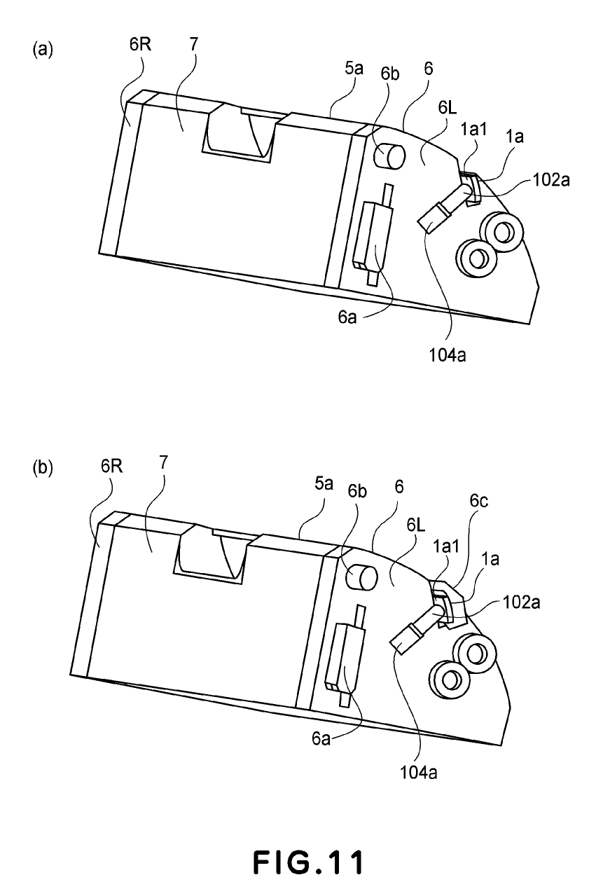

FIG. 10 is a sectional view showing a positional relationship between the main assembly electrical contact and the developing blade before mounting of the cartridge. FIGS. 11(a) and 11(b) are perspective views each showing a state in which the main assembly electrical contact contacts the developing blade contact surface of the developing blade. FIGS. 12(a) and 12(b) are sectional views each showing a positional relationship between the main assembly electrical contact and the developing blade after the mounting of the cartridge.

As shown in FIG. 10, the main assembly electrical contact 102a is provided to the rotary 101 of the main assembly 11. The main assembly electrical contact 102a provided to the rotary 101 is constituted by an urging spring 104a and a disengagement preventing portion 101b provided to the rotary 101. The main assembly electrical contact 102a is urged by an urging spring 104a in a direction of an arrow L, indicated in FIG. 10, crossing the developing blade contact surface 1a1 and is capable of being retracted in a direction of an arrow M, indicated in FIG. 12(a), crossing the developing blade contact surface 1a1. Therefore, as shown in FIG. 10, the main assembly electrical contact 102a placed in a non-contact state with the developing blade contact surface 1a1 is urged in the direction of the arrow L by the urging spring 104a and is regulated by the disengagement preventing portion 101b. Incidentally, in FIG. 10, main assembly electrical contacts 102b, 102c and 102d are provided correspondingly to developing blades of other developing cartridges 5b, 5c and 5d, respectively, and are configured similarly as in the case of the main assembly electrical contact 102a.

Further, as shown in FIGS. 11(a) and 11(b), the developing blade contact surface 1a1 is provided so as to be projected from the side member 6L of the yellow developing cartridge 5a at an end of the developing roller 2a with respect to the rotational axis direction of the developing roller 2a. The developing blade contact surface 1a1 constituted a surface crossing a direction of an arrow M, indicated in FIG. 10, which is the mounting direction of the cartridge to the main assembly, so that the main assembly electrical contact 102a is contactable to the crossing surface (contact surface) 1a1.

As shown in FIGS. 12(a) and 12(b), when the yellow developing cartridge 5a is mounted to the rotary 101 of the main assembly, the developing blade contact surface 1a1 which is a part of the developing blade projected from the other appearance shape of the yellow developing cartridge 5a directly contacts the main assembly electrical contact 102a. At this time, the main assembly electrical contact 102a urged by the urging spring 104a in the direction of the arrow L indicated in FIG. 10 is pressed by the developing blade contact surface 1a1 to be retracted into the direction of the arrow M indicated in FIG. 12(a). As a result, the main assembly electrical contact 102a provided to the main assembly 102a and the developing blade contact surface 1a1 as the part of the developing blade of the yellow developing cartridge 5a contact each other with reliability, so that it is possible to supply a voltage from the main assembly to the developing cartridge.

Further, in this embodiment, the main assembly electrical contact 102a is plated with chromiun and the developing blade contact surface 1a1 is plated with zinc. However, it is also possible to plate the main assembly electrical contact 102a with zinc and plate the developing blade contact surface 1a1 with chromium. That is, one of the main assembly electrical contact 102a and the developing blade contact surface 1a1 may be plated with chromium and the other portion may be plated with zinc. As a result, it is possible to realize stabilization of voltage supply.

As described above, in this embodiment, the main assembly electrical contact 102a provided to the main assembly 11 and the part of the developing blade 1 of the developing cartridge 5 directly contact each other. As a result, the voltage is directly supplied from the main assembly electrical contact 102a to the developing blade 1 of the developing cartridge 5 without using a contact member extending between the main assembly electrical contact and the developing blade. Therefore, the constitution for electrically connecting the main assembly and the cartridge with each other can be simplified by reducing the number of parts, thus realizing cost reduction and space saving.

### Second Embodiment

FIG. 11(b) and FIG. 12(b) illustrate Second Embodiment. In this embodiment, a part of the side member 6 is different from that in First Embodiment. That is, an end portion (a part) of the developing blade 1 with respect to the longitudinal direction of the developing blade 1 is covered with a covering portion 6c. More specifically, the covering portion 6c covers the rear surface of the contact surface 1a1 and rear surface edge portions of the contact surface 1a1 but exposes the front surface of the contact surface 1a1 toward the main assembly electrical contact 102a. As a result, it is possible to further effectively prevent the contact surface 1a1 from being touched by the user.

In the above-described embodiments, the developing cartridge 5 including the developing roller and the developing blade is described as the example of the cartridge detachably mountable to the image forming apparatus main assembly but the cartridge in the present invention is not limited thereto. For example, it is also possible to employ a process cartridge including at least the image bearing member (the photosensitive drum) and the developing means (including the developing roller and the developing blade) as the process means acting on the image bearing member. When the voltage is supplied from the main assembly electrical contact provided to the main assembly to the developing blade of the process cartridge, similarly as in the above-described embodiments, a part (an end portion) of the developing blade is projected from the outer appearance shape of the process cartridge. As a result, the voltage can be directly supplied without using a contact member extending between the main assembly electrical contact and the developing blade. Also by this constitution, similarly as in the above-described embodiments, the constitution for electrically connecting the main assembly with the cartridge can be simplified by reducing the number of parts, so that cost reduction and space saving can be realized.

Further, in the embodiments described above, the four developing cartridges are used but the number of the developing cartridges used is not limited thereto and may also be set appropriately as desired. Further, also in the case of the process cartridges, the number of the process cartridges may be appropriately set as desired.

Further, in the above-described embodiments, the printer is described as the example of the electrophotographic image forming apparatus but the present invention is not limited thereto. The electrophotographic image forming apparatus may also be other image forming apparatuses such as a copying machine, a facsimile machine, and a multi-function machine having functions of these machines. Further, the electrophotographic image forming apparatus is also not limited to such an image forming apparatus that respective color toner images are successively transferred onto the intermediary transfer member in the superposition manner and then are collectively transferred from the intermediary transfer member onto the recording material. For example, it is also possible to use such an image forming apparatus that respective color toner images are successively transferred in the superposition manner onto the recording material carried on a recording material carrying member. By applying the present invention to a cartridge detachably mountable to these image forming apparatuses, the effect of the present invention can be similarly achieved.

While the invention has been described with reference to the structures disclosed herein, it is not confined to the details set forth and this application is intended to cover such modifications or changes as may come within the purpose of the improvements or the scope of the following claims.

This application claims priority from Japanese Patent Applications Nos. 223044/2008 filed Sep. 1, 2008 and 181143/2009 filed Aug. 4, 2009, which is hereby incorporated by reference.

What is claimed is:

1. A cartridge detachably mountable to a main assembly of an electrophotographic image forming apparatus having a main assembly electrical contact, said cartridge comprising:
a developer carrying member for developing an electrostatic latent image formed on an image bearing member; and
an electroconductive developer layer thickness regulating member for regulating a layer thickness of a developer deposited on said developer carrying member;
wherein a part of said developer layer thickness regulating member is directly contactable to the main assembly electrical contact.

2. A cartridge according to claim 1, wherein said developer layer thickness regulating member includes a contact portion which is contactable to main assembly electrical contact, and
wherein the contact portion is projected from a frame of said cartridge with respect to a longitudinal direction of said developer layer thickness regulating member.

3. A cartridge according to claim 2, further comprising a projected portion projected from the frame of said cartridge with respect to the longitudinal direction of said developer layer thickness regulating member,
wherein the contact portion is disposed oppositely to the projected portion.

4. A cartridge according to claim 2, further comprising a covering portion for covering an end portion of said developer layer thickness regulating member with respect to the longitudinal direction of said developer layer thickness regulating member in a state in which the contact portion is exposed.

5. A cartridge according to claim 3, wherein the projected portion functions as a portion to be guided by the main assembly when said cartridge is mounted to and demounted from the main assembly.

6. A cartridge according to claim 3, wherein the projected portion functions as a portion to be positioned with respect to the main assembly in a state in which said cartridge is mounted to the main assembly.

7. A cartridge according to claim 1, wherein said developer layer thickness regulating member includes a contact portion which is contactable to the main assembly electrical contact, and
wherein the contact portion is located below said developer layer thickness regulating member when said cartridge is mounted outside the main assembly.

8. A cartridge according to claim 1, wherein said developer layer thickness regulating member includes a contact portion which is contactable to the main assembly electrical contact, and
wherein the contact portion has a surface crossing a mounting direction of said cartridge toward the main assembly, and
wherein the main assembly electrical contact is contactable to the surface.

9. A cartridge according to claim 1, wherein said developer layer thickness regulating member includes a contact portion which is contactable to the main assembly electrical contact, and
wherein one of the main assembly electrical contact and the contact portion is plated with chromium and the other one is plated with zinc.

10. A cartridge according to claim 1, further comprising the image bearing member.

11. An electrophotographic image forming apparatus for forming an image on a recording material, comprising:
(a) a main assembly electrical contact;
(b) a cartridge detachably mountable to a main assembly of an electrophotographic image forming apparatus having a main assembly electrical contact, said cartridge comprising:
a developer carrying member for developing an electrostatic latent image formed on an image bearing member; and
an electroconductive developer layer thickness regulating member for regulating a layer thickness of a developer deposited on said developer carrying member;
wherein a part of said developer layer thickness regulating member is directly contactable to the main assembly electrical contact; and
(c) conveying means for conveying the recording material.
